(19) United States
(12) Patent Application Publication
(10) Pub. No.: US 2026/0172398 A1
(43) Pub. Date: Jun. 18, 2026

(54) CONFIDENTIAL COMPUTING MANAGEMENT FROM CLOUD BASED SERVICES

(71) Applicant: American Megatrends International, LLC, Duluth, GA (US)

(72) Inventor: CHITRAK GUPTA, Johns Creek, GA (US)

(21) Appl. No.: 18/983,909

(22) Filed: Dec. 18, 2024

(51) Int. Cl. H04L 9/40

(52) U.S. Cl. CPC H04L 63/029; H04L 63/105

(57) ABSTRACT

In an aspect of the disclosure, a method, a computer-readable medium, and a system are provided. The apparatus may include one or more computing devices. The one or more computing devices obtain a manifest file for a service executing on an embedded system. The manifest file specifies whether the service requires a simple protection mode or an enhanced protection mode. The one or more computing devices register the service with the confidential computing gateway based on the manifest file. The one or more computing devices receive, at a confidential computing gateway, a request from an interface application to access the service. The one or more computing devices determine, based on the manifest file, whether the service requires the enhanced protection mode.

### BACKGROUND

Field

The present disclosure relates generally to computer systems, and more particularly, to techniques of implementing policy management of secured access in a confidential computing environment through a confidential computing gateway.

### BACKGROUND

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Embedded systems like BMCs and other ARM-based System-on-Chips (SoCs) provided extensive manageability features that allowed complete access to system devices and resources. These embedded systems typically implemented basic security through authentication mechanisms like username/password checks and role-based access controls. However, these traditional security approaches treated all services uniformly and lacked granular control over different types of operations within the same service.

The ARM Confidential Compute Architecture (ARM CCA) introduced hardware-based security features that enabled the creation of isolated execution environments specifically the Rich Execution Environment (REE) and Trusted Execution Environment (TEE). This architecture provided the foundational capability to protect sensitive code and data through hardware-enforced isolation. However, while ARM CCA defined the hardware mechanisms for creating secure environments, it did not specify how to determine which parts of applications or services should run in the TEE versus the REE, leaving this critical policy decision to system implementers. Embedded system security may be implemented through static configurations defined at build time and scattered across various configuration files or hard-coded into application logic. This approach made it difficult to adapt security policies as deployment conditions changed or new security requirements emerged. For example, a firmware image designed to work across multiple platforms could not easily adjust its security controls based on whether it was deployed in a secure data center or at the network edge where security risks might be higher.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The apparatus may include one or more computing devices. The one or more computing devices obtain a manifest file for a service executing on an embedded system. The manifest file specifies whether the service requires a simple protection mode or an enhanced protection mode. The one or more computing devices register the service with the confidential computing gateway based on the manifest file. The one or more computing devices receive, at a confidential computing gateway, a request from an interface application to access the service. The one or more computing devices determine, based on the manifest file, whether the service requires the enhanced protection mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a BMC implementation with various services and a cloud storage system for storing system archives.

FIG. 3 is a diagram illustrating an embedded system infrastructure that supports a host, storage, network, and accelerators.

FIG. 4 is a diagram illustrating a confidential computing architecture for an embedded system with a gateway that acts as a central security control point.

FIG. 5 is a diagram illustrating a cloud-based confidential computing architecture for managing security policies across multiple embedded systems.

FIG. 6 is a diagram presenting a table that illustrates the structure of a manifest file used to define security policies for services within an embedded system.

FIG. 7 is a diagram illustrating a confidential computing interface design that implements a trust boundary-based architecture for secure service communication.

FIG. 8 is a flow chart of a method for managing secure access to services in an embedded system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

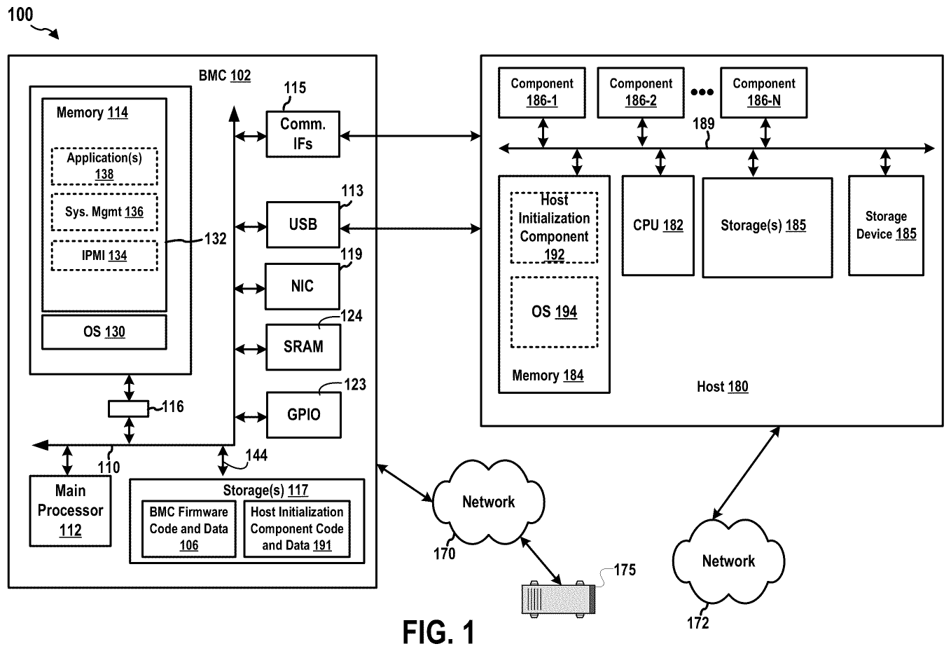

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

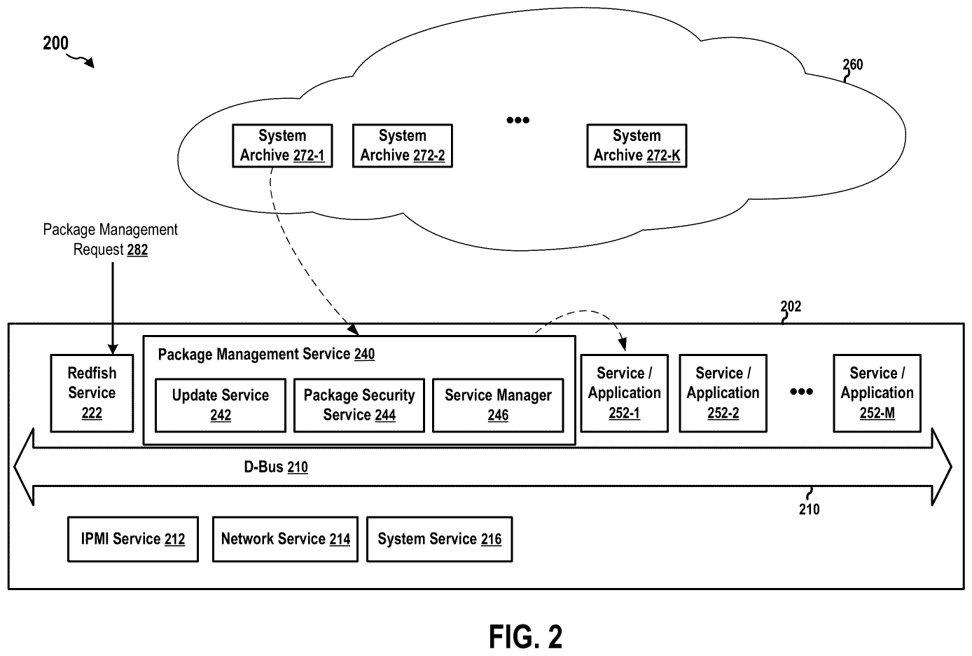

FIG. 2 is a diagram 200 illustrating a BMC implementation. A BMC 202 is an implementation of the BMC 102. The BMC 202 executes, among other services/applications, an IPMI service 212, a network service 214, a system service 216, a REDFISH service 222, a package management service 240, services/applications 252-1, 252-2, . . . , 252-M. A cloud storage 270 stores system archives 272-1, 272-2, . . . , 272-K. Each of the system archives 272-1, 272-2, . . . , 272-K is a secure location where updatable packages of a corresponding service/application (e.g., one of the services/applications 252-1, 252-2, . . . , 252-M) of a BMC are kept. Further, the package management service 240 includes an update service 242, a package security service 244, and a service manager 246.

The REDFISH service 222 serves as the bridge between remote management actions and the BMC 202, enabling cloud-based package management in a secure and standard manner.

The REDFISH service 222 allows external components to interact with and send commands to the BMC 202. The REDFISH service 222 implements a RESTful interface and may utilize standard HTTP(S) and JSON to provide access to data center hardware management functions.

The REDFISH service 222 provides the REDFISH API, which is the mechanism of communication between a remote management console and the BMC 202 for package management-related operations. The operations may include activities such as installing new software, updating existing software, or removing software from the system.

Once the package management commands are sent through the REDFISH interface, they are received by the package management service 240 running on the BMC 202. The package management service 240 is responsible for initiating and managing the actions requested through the REDFISH API calls. In particular, the package management service 240 interacts with the cloud storage 270. It is from this repository that the package management service 240 will fetch the software packages needed for installation or updates.

The package management service 240 of the BMC 202 has the capability to install, remove, and upgrade packages during the runtime of the system. The cloud storage 270 provides packages that can be installed or updated on the BMC 202. Similar to the functionality available in Linux distributions, a user can use package management commands such as “apt install <pkg-name>” to manage (e.g., install, updat, or remove) software packages. This functionality is made possible through the use of the REDFISH Software Installation service of the REDFISH service 222, as described supra.

The package management service 240 supports various package file formats for software deployment within the BMC 202. For example, RPM (Red Hat Package Manager) and DEB (Debian package) may be supported. RPM and DEB are common packaging formats used in Linux distributions for managing individual software packages, which contain the executable, configuration files, and metadata relevant to the software. This conformity to widely adopted packaging standards facilitates interoperability and the use of established tools and practices in package management.

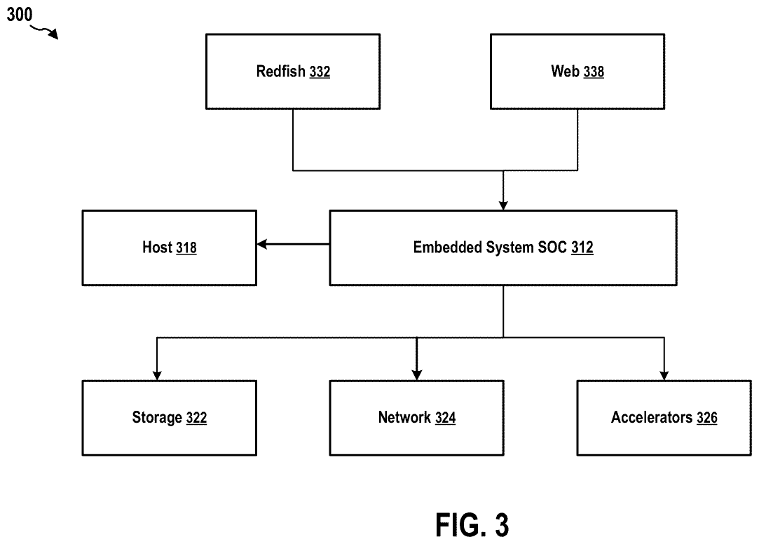

FIG. 3 is a diagram 300 illustrating an exemplary embedded system infrastructure that supports a host 318, a storage 322, a network 324, and accelerators 326. The embedded system SOC 312 forms the core of this infrastructure and communicates with external interfaces, including a Redfish interface 332 and a Web interface 338, to handle management requests and data exchanges. The embedded system SOC 312 may be capable of controlling various devices and subsystems. However, there can be significant challenges in maintaining secure and controlled access to sensitive resources, especially when dealing with external requests that originate from networked management interfaces.

Embedded systems may suffer from difficulties in granularly controlling and protecting access to critical resources and processes. The SOC 312, which manages a spectrum of services, may lack adequate mechanisms to differentiate among services that require varying levels of access privileges. For instance, a particular service may handle both benign operations, such as reading sensor data, and sensitive operations, such as modifying RAID configurations of attached storage controllers or reconfiguring critical system settings in the host 318. Without adequate segmentation, all requests that pass through the Redfish 332 or Web interface 338s are treated in a uniform manner, simply authenticated via conventional username and password checks or other basic access controls. As a result, a malicious attacker who gains unauthorized access or exploits a software vulnerability can escalate privileges or issue destructive commands that compromise the system's data integrity, device functionality, or entire system stability.

Further complications arise due to static and rigid configurations stored at build time. Without dynamic policy management, the firmware developer cannot easily adapt the system's security mechanisms as the target platform evolves. For example, a single firmware image intended to operate across multiple embedded platforms and ARM-based SoCs might not account for unique security requirements that change when the system is deployed in different network environments or hardware configurations. In these scenarios, the trust boundary is not well-defined, and no strong isolation mechanisms are present to separate critical services from less sensitive ones. The embedded system SOC 312 and its integrated manageability features, even when aligned with ARM Confidential Compute Architecture concepts, do not natively provide a convenient framework to specify and enforce fine-grained access policies at runtime. Instead, the policies may need to be hard-coded into the firmware or distributed across various configuration files, complicating updates and increasing the risk of misconfiguration or overlooked vulnerabilities.

In the environment depicted in FIG. 3, network-driven requests can originate from multiple endpoints, including remote management consoles interfacing through the Redfish interface 332 or general web services via the Web interface 338. Without a robust means of identifying critical resources and applying enhanced security checks for sensitive operations, these incoming requests flow directly into the embedded system SOC 312's internal logic and potentially the host 318. Although embedded systems have evolved to incorporate some safeguards, attackers can still identify vulnerable entry points and exploit them due to insufficient mechanisms to dynamically classify and control access at a granular level. As such, maintaining system trustworthiness relies heavily on static code-level checks or monolithic access control lists, which are neither scalable nor adaptable to the emerging use cases and threat models faced by embedded devices in modern data centers, IoT deployments, and complex networking environments.

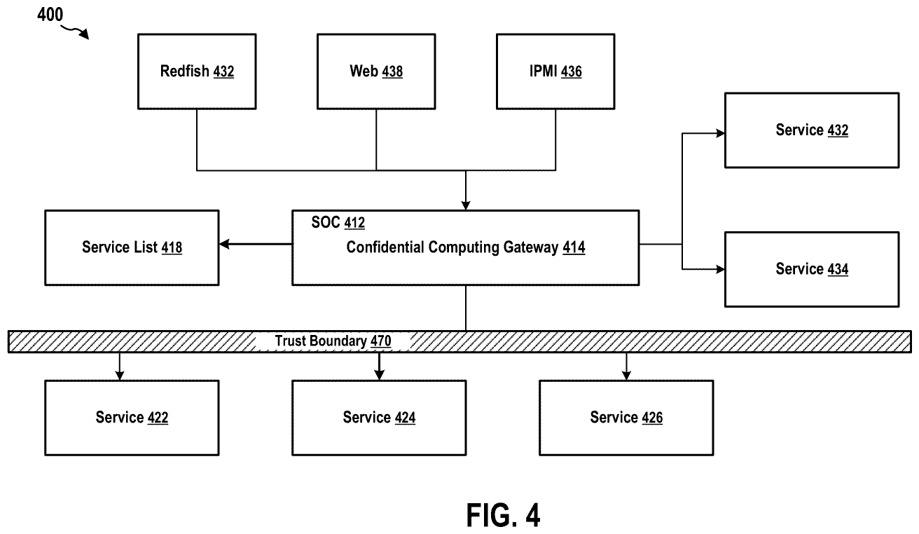

FIG. 4 is a diagram 400 illustrating a confidential computing architecture for an embedded system. The architecture includes an embedded system SoC 412 implementing a confidential computing gateway 414 that acts as a central security control point, interfacing between external interfaces and internal services. The external interfaces include a Redfish interface 432, a Web interface 438, and an IPMI interface 436, which provide access points for management and control operations. A service list 418 maintains a database of registered services and their security configurations.

The confidential computing gateway 414 functions as an intermediary between external interfaces, internal services, and host-resident resources. The embedded system SoC 412 communicates with various management interfaces, such as the Redfish interface 432, the Web interface 438, and the IPMI interface 436. These management interfaces may receive requests originating from external networks or clients that seek to access the device's functionalities, such as querying system metrics, configuring storage controllers, or managing user credentials. In this architecture, the confidential computing gateway 414, residing within the SoC 412, establishes a trust boundary 470.

Outside (above) the trust boundary 470, the architecture includes multiple services, such as a service 432 and a service 434, that operate in a non-critical protection mode. These services typically handle operations that do not require enhanced security measures, such as reading sensor data or retrieving basic system information. The trust boundary 470 represents a security demarcation line that may be implemented through the ARM Confidential Compute Architecture's hardware-based isolation mechanisms.

Inside (below) the trust boundary 470, the architecture includes services, such as the services 422, 424, and 426, that operate in an enhanced protection mode. These services handle critical operations that require elevated security measures, such as modifying BIOS settings, updating firmware, or configuring storage controllers. The enhanced protection mode may utilize the ARM Trusted Execution Environment to provide hardware-backed isolation and security guarantees.

Services that require enhanced protection operate behind this trust boundary, while less sensitive services can remain accessible with simpler controls. For example, simple read-only operations that retrieve sensor information or system states can be considered non-critical, and therefore these requests flow directly to the appropriate services without stringent checks. In contrast, write operations or configuration changes that impact the system's integrity or data confidentiality require more robust scrutiny.

Further, a single process may include both read APIs and write APIs, and thus the architecture is designed to allow segregation of functions within a process to allow the write API to be handled with stronger protection, while allowing the read API to operate in a non-critical protection mode.

To achieve this fine-grained policy enforcement, each service is associated with a manifest file presented to the confidential computing gateway 414 at initialization. This manifest specifies whether the service requires a simple or enhanced protection mode. Under the simple mode, the gateway may rely on conventional authentication methods, while under the enhanced mode, the gateway subjects incoming requests to additional validations. These validations may include matching request payloads against known patterns, verifying user privileges, and filtering out unauthorized commands.

Validation may include checking for specific signature patterns in a payload. In the enhanced mode, the gateway may route requests to services that are protected by the confidential computing mechanism, further isolating sensitive operations and files. For instance, configuration objects, databases, or sensitive API endpoints are only accessible if the request conforms to the rules and restrictions set forth in the manifest. In the enhanced protection mode, similar services can choose to protect files like configuration files and databases under the confidential computing service.

A cloud platform, acting as a policy management solution, can dynamically provision these manifest files and adjust the security profiles of services in response to changing deployment conditions. By providing this flexibility at build time and runtime, the system can adapt to differing hardware configurations, deployment scenarios, or newly discovered security requirements. The firmware provider and other stakeholders can rely on the cloud platform to deliver updated policies and configurations whenever the environment evolves, enabling the embedded system to maintain a suitable trust boundary over time.

The cloud platform allows a user to specify, for different devices, which services will require enhanced security. The manifest file is dynamically configurable and allows for the security needs to change based on where a device is located (e.g., on the edge or in a data center).

The confidential computing gateway 414 functions as an internal API gateway. It intercepts all requests from external interfaces and routes them to the appropriate services based on their security requirements. If a service requires enhanced protection, the gateway performs the validations specified in the manifest file. For example, for a Redfish service, a read request for sensor information may be handled without additional security checks, but a request to configure the server system would be routed through the confidential computing gateway 414 and be subject to additional validations. The confidential computing gateway 414, in operation, does not expose any APIs, but performs security functions, monitoring and validation of incoming requests.

Further, the confidential computing architecture may build upon the ARM Trusted Environment by adding a policy layer that determines which parts of a process are run in a Rich Execution Environment (RE), and which parts are run in a Trusted Execution Environment (TE). The manifest file is configured to specify what parts of a process need elevated security and hardware-backed isolation. This enables the system to run a service in a less-privileged mode as well as in an enhanced protection mode. Furthermore, the cloud platform build orchestrator can enable configuration of features that require enhanced security during build time. The manifest file includes the processes and supported API interfaces that need to be controlled with more granular access control.

The architecture makes it feasible to implement a role based access control by defining different privilege levels and by controlling the API level of access, rather than controlling the process itself.

ARM REE (Rich Execution Environment) and ARM TEE (Trusted Execution Environment) are two distinct operational domains defined within ARM-based computing platforms, each with different security and trust properties. The REE is the conventional, general-purpose operating environment where typical operating systems and applications run. It provides a full-featured environment, supporting a wide range of services, peripherals, and user interfaces. However, the REE is considered less secure since it often includes large, complex software stacks (such as Linux or Android) that may be more susceptible to vulnerabilities and attacks. In the REE, applications and the OS have direct access to most system resources, but they operate at a lower level of trust. The TEE is a secure, isolated execution environment designed to run sensitive code and manage confidential data in a way that protects it from unauthorized access or modification. It uses hardware-enforced isolation mechanisms to ensure its integrity, even if the REE is compromised. In the TEE, a much smaller and more tightly controlled set of trusted applications and services execute. These trusted components handle critical operations, such as key management, secure storage, and cryptographic functions, all shielded from external interference.

In certain configurations, the ARM Confidential Compute Architecture may be used to provide the hardware configurations necessary for creating isolated execution environments, namely the REE and the TEE. When a service requires enhanced protection as specified in its manifest file, the service, or the critical parts of the service, are run within the TEE. This involves loading the service code, or relevant parts of it, into secure memory regions designated for the TEE. The ARM hardware enforces the isolation between the TEE and the REE, preventing untrusted processes or external threats from accessing sensitive operations or data handled within the TEE.

For instance, if a service includes both read-only operations that are considered safe and write operations that modify critical system configurations, the manifest file can specify that only the write operations need to be run in the TEE. The confidential computing gateway 414 orchestrates this by directing calls to the write APIs through the secure environment, while allowing read operations to proceed in the REE. This selective execution helps in optimizing system performance by limiting the use of the TEE to operations that truly require enhanced security.

The use of manifest files allows for these decisions to be made dynamically and updated as needed. If at any point the security requirements change, the cloud platform can provide updated manifest files that adjust which services or APIs need to be secured.

Consider a scenario where a firmware provider is deploying firmware for an embedded system SoC 412 that will operate in different environments. For devices deployed at the edge, there may be a need for tighter security controls due to increased exposure to potential threats. During the firmware build process, the cloud platform generates manifest files that specify enhanced protection for services handling sensitive operations, such as modifying BIOS settings or configuring storage controllers.

When the device is powered on, services initialize and register themselves with the confidential computing gateway 414 by providing their manifest files. The gateway reads the manifest and updates its configuration database accordingly. For services requiring enhanced protection, the gateway routes incoming requests through the TEE. It validates user credentials, checks payload formats against defined patterns in the manifest, and enforces access controls at the API level.

For example, if a Redfish request is received via the Redfish interface 432 to change BIOS settings, the confidential computing gateway 414, recognizing this as a sensitive operation, verifies that the request is coming from a trusted source, such as a specific IP address or domain. It also checks that the payload conforms to expected formats and that the user has the necessary privileges as defined in the manifest. Only after these validations does the gateway allow the operation to proceed within the TEE, thereby protecting the operation from potential interference or eavesdropping.

In contrast, less sensitive requests, such as retrieving sensor data, are routed directly to the appropriate service operating in the REE without additional security checks. This approach balances the need for security with system performance, ensuring that only operations that truly require enhanced protection incur the overhead associated with the TEE.

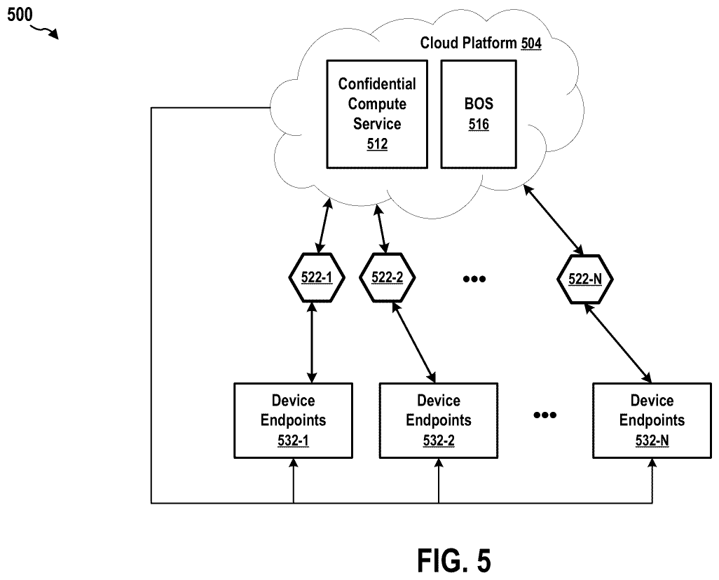

FIG. 5 is a diagram 500 illustrating a cloud-based confidential computing architecture for managing security policies across multiple embedded systems. The architecture includes a cloud platform 504 that provides a confidential computing service 512 and a build orchestration service (BOS) 516. The cloud platform 504 communicates with and manages multiple embedded systems 522-1, 522-2, . . . , 522-N, which in turn interface with their respective device endpoints 532-1, 532-2, . . . , 532-N.

The confidential computing service 512 functions as a centralized policy management system that creates and distributes security manifests to the embedded systems. Each manifest file defines the protection requirements for services running on the embedded systems, specifying whether a service requires simple protection mode or enhanced protection mode. The manifest files support granular control at the API level, allowing different security treatments for read-only operations versus confidential write operations within the same service.

The BOS 516 works in conjunction with the confidential computing service 512 to enable dynamic configuration of security features during the firmware build process. When creating firmware for different platforms or deployment scenarios, the BOS 516 can incorporate platform-specific security requirements into the manifest files. For example, an embedded system deployed at the network edge might receive manifest files that specify enhanced protection for a broader set of services compared to a system operating within a secure data center.

During system initialization, each service in an embedded system (522-1, 522-2, . . . , 522-N) registers itself with its local confidential computing service and present its configuration manifest file. The registration process establishes a security profile for the service, which determines how subsequent access requests will be handled. Services that do not register or do not have associated manifest files are designated as non-critical and operate without enhanced protection.

The manifest file structure supports rich configuration options for services requiring enhanced protection. For each protected resource, the manifest specifies authorized users, privilege levels, and permitted endpoints. Service developers can define signature patterns for acceptable resource access requests, and any requests that do not match these patterns are rejected. For example, a manifest might specify that configuration changes to storage controllers can only be initiated from specific IP addresses or must contain particular payload signatures.

When a client application attempts to access a managed resource through interfaces such as Redfish, Web CGI, or IPMI handlers, the request is first routed through the local confidential computing service. This service consults its configuration database, which contains the processed manifest files, to determine the appropriate security controls. While standard authentication mechanisms remain in place, the confidential computing service adds an additional layer of API-level control based on the manifest specifications.

The architecture supports dynamic updates to security policies through the cloud platform 504. If hardware platform modifications occur or security requirements change, the confidential computing service 512 can generate and distribute updated manifest files to the affected embedded systems. This capability allows security policies to evolve with changing deployment conditions or newly discovered security requirements without requiring firmware updates.

The manifest files also enable fine-grained access control based on user privileges. For example, a manifest can specify that certain APIs are accessible only to users with superuser privileges, while others can be accessed by users with lower privilege levels. The manifest can also define different payload format requirements and file access permissions for different privilege levels, providing a comprehensive security policy framework that operates at both the service and API levels.

The confidential computing gateway 414 and the confidential computing service 512 operate in a hierarchical relationship where the confidential computing service 512 in the cloud platform 504 acts as the centralized policy management system that creates and distributes security manifests, while the confidential computing gateway 414 serves as the local enforcement point within each embedded system that implements and enforces these security policies.

The confidential computing service 512 resides in the cloud platform 504 and works in conjunction with the BOS 516 to generate manifest files that define the security requirements for services running on embedded systems. These manifest files specify whether services require simple or enhanced protection modes and define granular access controls at the API level. The confidential computing service 512 has a global view across multiple embedded systems (522-1, 522-2, . . . , 522-N) and can dynamically update security policies based on changing deployment conditions or security requirements.

The confidential computing gateway 414, on the other hand, operates locally within each embedded system SoC 412 and serves as the enforcement mechanism for the security policies defined by the manifest files distributed from the confidential computing service 512. It acts as an internal API gateway that intercepts all requests from external interfaces (such as Redfish interface 432, Web interface 438, and IPMI interface 436) and enforces the security controls specified in the manifest files. When services initialize, they register with the confidential computing gateway 414 and present their manifest files, which the gateway uses to establish appropriate security controls.

The relationship between these components enables a dynamic and adaptable security framework. The confidential computing service 512 can update manifest files based on global security requirements or specific deployment scenarios (such as edge vs. data center deployments), and the confidential computing gateway 414 implements these changes locally within each embedded system. This architecture allows for centralized policy management while maintaining robust local enforcement of security controls.

Where ARM's Confidential Compute Architecture is used, the confidential computing gateway 414 implements the local trust boundary 470 and manages the routing of operations between the Rich Execution Environment (REE) and Trusted Execution Environment (TEE) based on the policies defined in the manifest files received from the confidential computing service 512. This enables hardware-backed isolation for sensitive operations while allowing less critical operations to proceed with minimal overhead.

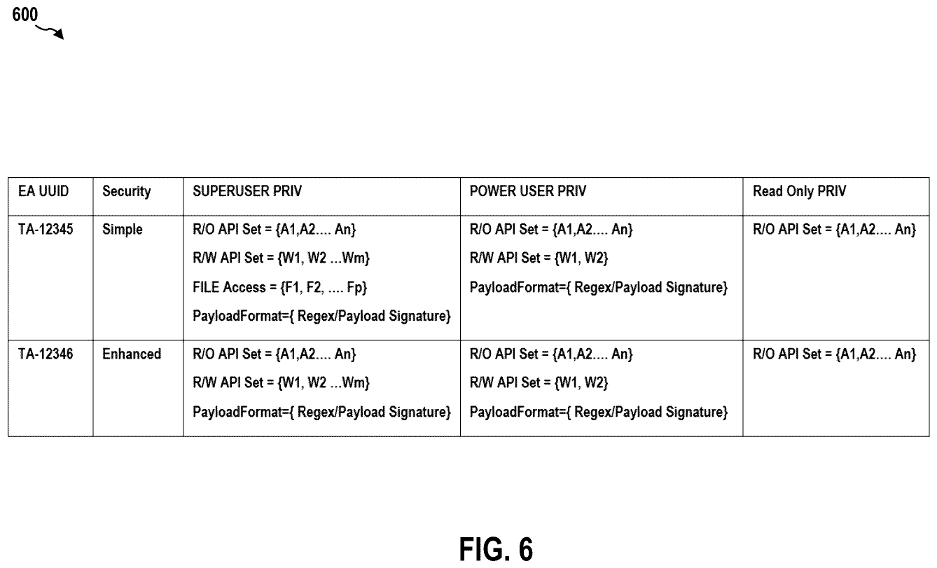

FIG. 6 presents a table 600 that illustrates the structure of a manifest file used by the confidential computing gateway 414 to define security policies for services within an embedded system. Each row in the table represents a different service, identified by a unique Entity Association (EA) UUID, and the columns define the security level and access privileges for that service. The manifest file is, in one example, stored as a JSON document and is used by the cloud platform as a dynamic configuration file. The table provides a visual representation of the manifest file's structure and content.

The first column, labeled “EA UUID”, uniquely identifies each service. For example, “TA-12345” and “TA-12346” are two such identifiers. The “Security” column specifies the protection mode for each service. A service may operate in a “Simple” protection mode, which implies that the service does not require enhanced security, or the service may operate in an “Enhanced” protection mode which indicates that the service requires elevated security. The manifest file is configured during build time, and the manifest file may be modified during runtime by the cloud platform.

The subsequent columns define the access privileges for different user roles: SUPERUSER PRIV, POWER USER PRIV, and Read Only PRIV. These privileges are specified as sets of APIs and file accesses, along with payload formats. The “SUPERUSER PRIV” column specifies access privileges for a super user, which can include read-only APIs, read-write APIs, file access and a payload format that is expected. For instance, a superuser might have access to both read and write APIs (e.g., “R/O API Set=A1, A2 . . . , An; R/W API Set=W1, W2 ... Wm”) and full file access (e.g., “FILE Access=F1, F2, . . . , Fp”) as well as defined payload format requirements (e.g., “PayloadFormat=Regex/Payload Signature”). A power user may have access to fewer API sets than a superuser, such as access to read only and read-write APIs, but may not have access to file systems. A read-only user may only have access to read-only APIs.

For a service operating under a simple protection mode, the manifest file may allow access to files, as shown for “TA-12345”. For example, a power user may have access to “R/O API Set=A1,A2 . . . , An; R/W API Set=W1, W2” and a specified payload format. However, for enhanced protection, such as “TA-12346,” the manifest file may restrict file access to only the super user. Additionally, the manifest specifies a payload format which is a regular expression or a payload signature, which is checked by the confidential computing gateway 414 against any incoming requests. In that way, the confidential computing gateway 414 controls the type of data allowed in the payload for a specific API.

The manifest file allows a firmware provider to define granular access control policies at the API level. For instance, the same service can have both read APIs and write APIs, where write APIs are protected by the enhanced security mode by execution in the Trusted Execution Environment (TEE), while read APIs can be executed in the Rich Execution Environment (REE) with less protection. This dynamic approach ensures that services only have the minimum necessary privileges. The cloud platform provides dynamic manifest files, which can be updated at build time or during runtime based on system needs.

The confidential computing gateway 414 implements payload validation mechanisms to prevent malicious or unauthorized configuration changes. For example, in a system with multiple hard drives configured in a RAID array, the gateway can enforce strict payload format requirements. If the system specifically requires RAID 10 configuration, the gateway examines incoming configuration requests and blocks any attempts to establish alternative RAID levels, such as RAID 5. This validation occurs through regular expression pattern matching or keyword analysis of the payload content.

The manifest file structure, as illustrated in table 600, enables granular access control without requiring modifications to the application code. Rather than embedding security checks within each process, which could lead to inconsistencies or oversights, the security policy is abstracted into the manifest file and enforced uniformically by the confidential computing gateway 414. This centralized approach reduces the risk of security vulnerabilities that might arise from scattered or incomplete access controls within individual applications.

When a request arrives through any interface, such as the Web interface 438 or TCP/IP connection, it is first intercepted by the confidential computing gateway 414. The gateway consults the manifest file associated with the target process to determine the appropriate security controls. For applications marked with simple security, the gateway functions primarily as a routing mechanism. However, for applications requiring enhanced protection, the gateway implements comprehensive request validation, examining the source, payload format, and access privileges before allowing the request to proceed.

The cloud platform enables dynamic adaptation of security policies based on deployment context. For instance, when a device operates at the network edge where security risks are elevated, the manifest file can be configured to place more services under enhanced protection. The same service that operates with simple protection in a secure data center environment may require stricter controls when deployed at the edge. This flexibility extends to API-level granularity-within a single service, specific APIs can be designated for enhanced protection while others operate under simple protection.

The manifest file structure supports role-based access control through its privilege hierarchy. As shown in table 600, a superuser may have access to both read-only and read-write API sets, along with file access permissions, while a read-only user is restricted to read-only APIs. The gateway enforces these privileges by validating each request against the permitted operations defined in the manifest file for the requester's privilege level.

The confidential computing gateway 414 acts as an API gateway, creating internal clients for the services it manages. This architecture eliminates the need for individual applications to implement their own security controls, as all API calls are mediated by the gateway according to the policies defined in the manifest files. The gateway's position within the trust boundary 470 provides a consistent security enforcement point for all incoming requests, regardless of their source or destination service.

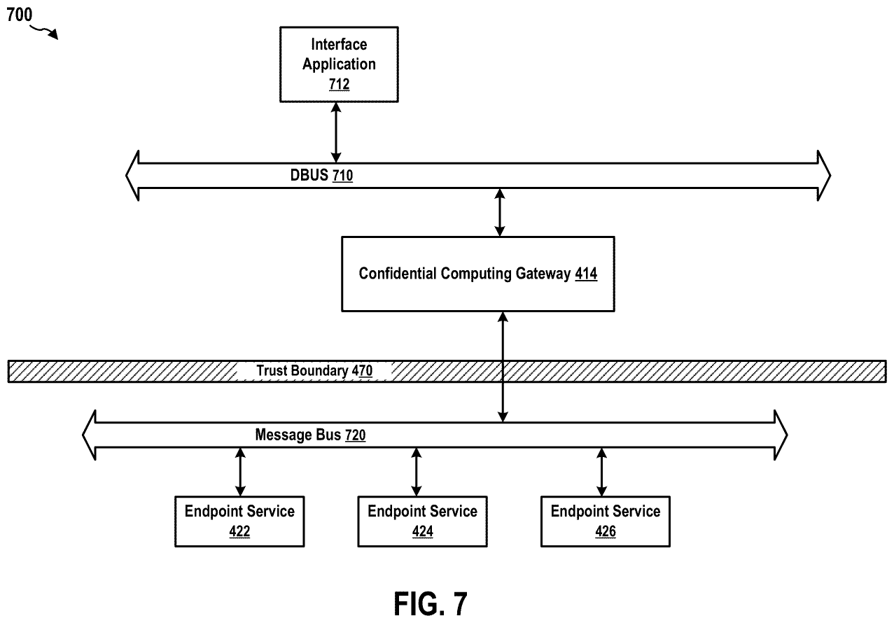

FIG. 7 is a diagram 700 illustrating a confidential computing interface design that implements a trust boundary-based architecture for secure service communication. An interface application 712 may interact with endpoint services 422, 424, and 426 through a confidential computing gateway 414. The architecture uses a DBUS 710 for communication between the interface application 712 and the confidential computing gateway 414, and a message bus 720 (e.g., a zMQ based message bus) for communication between the confidential computing gateway 414 and the endpoint services 422, 424, and 426. This setup is designed to provide a secure communication path and a trust boundary 470 for critical operations within an embedded system. The trust boundary 470 separates trusted components from components that may not be fully trusted.

The interface application 712 represents the point where external requests enter the system, such as those from a Redfish, Web, or IPMI interface. Instead of directly accessing endpoint services, requests are routed through the DBUS 710 to the confidential computing gateway 414. The confidential computing gateway 414, as an API gateway, decides whether to route the requests to enhanced protection services (inside the trust boundary) or to non-critical services (outside the trust boundary). This decision is based on the manifest file associated with the targeted service. Unlike a traditional implementation where interface applications directly communicate with endpoint services through exposed interfaces on a DBUS, this architecture enforces a strict security boundary through the gateway.

The confidential computing gateway 414 exposes only a single interface on the DBUS 710, which acts as a call broker between the interface application 712 and the secure endpoint services. This design significantly reduces the attack surface by limiting direct access to endpoint services. The gateway may implement a Zero Message Queue (ZMQ) based message bus 720 with an asynchronous broker pattern to handle communication between the gateway and endpoint services.

When a request arrives from the interface application 712, it first reaches the confidential computing gateway 414 through the DBUS 710. The gateway processes the incoming request based on the security policies defined in the manifest files. For requests targeting services requiring enhanced protection, the gateway performs additional validation checks before forwarding the request through the message bus 720 to the appropriate endpoint service.

For enhanced protection services, which are represented by endpoint services 422, 424, and 426, the confidential computing gateway 414 uses the message bus 720 to send requests. The message bus 720 uses an asynchronous broker pattern for communication, which allows the confidential computing gateway 414 to send a request and continue with other tasks. The confidential computing gateway 414 receives the payload, the endpoint service information, and then sends a command plus payload data to the endpoint service. The endpoint service processes the request and sends a response back to the confidential computing gateway 414 through the message bus 720. The confidential computing gateway 414 then repackages the response as a DBUS response and sends it back to the interface application 712. This structure makes the confidential computing gateway 414 a central control point for all requests to the protected endpoint services.

This implementation may manage access in an environment like the OpenBMC where Dbus is used for IPC. In other implementations, a web server with an API gateway may be used. In this structure, the validation is done by the confidential computing gateway 414.

The architecture provides a mechanism to route certain processes into a protected mode (e.g., trusted execution environment), where all access is controlled not only by username and password but also by a trust boundary and controlled access. The manifest files described in FIG. 6 will provide the security policy to the confidential computing gateway 414 during bootup or when the service is being initiated. The endpoint services 422, 424 and 426 are the critical services and resources such as user databases, certificate stores, and device configurations methods that are accessible via the message bus 720.

While the described implementation utilizes ARM's Confidential Compute Architecture, the system can be adapted to work with other hardware vendors'confidential computing technologies, such as Intel's Software Guard Extensions (SGX) and AMD's Secure Encrypted Virtualization (SEV). These alternative architectures provide similar capabilities for creating isolated execution environments and hardware-backed security features.

For Intel systems, the confidential computing gateway 414 can use Intel SGX to create secure enclaves instead of ARM's Trusted Execution Environment (TEE). Intel SGX provides hardware-enforced memory encryption and isolation for sensitive code and data, similar to ARM's TEE. The manifest files would specify which services or APIs need to be executed within SGX enclaves rather than in the TEE.

Similarly, for AMD systems, the architecture can utilize AMD SEV, which provides memory encryption for virtual machines and secure key management. The confidential computing gateway 414 would work with AMD SEV to create protected execution environments for services requiring enhanced protection mode, as specified in their manifest files.

The cloud platform 504 still generates and distributes manifest files, and the confidential computing gateway 414 still enforces security policies based on these manifests. Instead of using ARM's Rich Execution Environment (REE) and TEE, the system would use the respective secure execution environments provided by Intel SGX or AMD SEV.

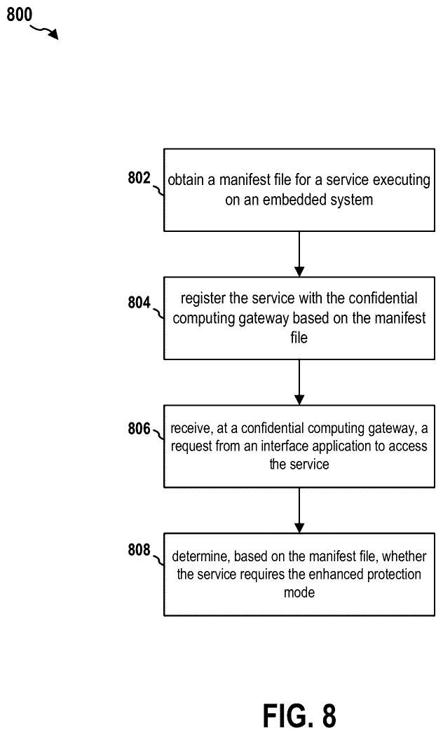

FIG. 8 is a flow chart 800 of a method for managing secure access to services in an embedded system. The method may be performed by one or more computing devices (e.g., the confidential computing gateway 414). In operation 802, the one or more computing devices obtain a manifest file for a service executing on an embedded system, the manifest file specifying whether the service requires a simple protection mode or an enhanced protection mode. In operation 804, the one or more computing devices register the service with the confidential computing gateway based on the manifest file. In operation 806, the one or more computing devices receive, at a confidential computing gateway, a request from an interface application to access the service. In operation 808, the one or more computing devices determine, based on the manifest file, whether the service requires the enhanced protection mode.

When the service requires the enhanced protection mode, the one or more computing devices validate the request according to security requirements specified in the manifest file and route the request to the service through a trusted execution environment when the validation succeeds. To validate the request, the one or more computing devices determine whether a payload format of the request matches a signature pattern specified in the manifest file for the service.

When the service requires the simple protection mode, the one or more computing devices route the request directly to the service without performing additional security validation.

In certain configurations, the manifest file specifies a first set of APIs of the service requiring the enhanced protection mode and a second set of APIs of the service requiring the simple protection mode. The one or more computing devices route requests for APIs in the first set through a trusted execution environment and route requests for APIs in the second set directly to the service.

The one or more computing devices receive, from a cloud platform, an updated manifest file for the service and update security requirements for the service based on the updated manifest file during runtime.

To register the service, the one or more computing devices store, in a configuration database, security requirements specified in the manifest file and establish a communication channel with the service through a message bus.

In certain configurations, the manifest file specifies different access privileges for different user roles. The one or more computing devices determine a user role associated with the request and validate the request based on access privileges specified for the determined user role. The access privileges specify read-only API sets, read-write API sets, and file access permissions for each user role.

The one or more computing devices receive requests from multiple interface applications through different protocols, route all requests through the confidential computing gateway, and maintain a single trust boundary for accessing services requiring the enhanced protection mode.

In certain configurations, the manifest file is generated during a build process of firmware for the embedded system based on deployment requirements of the embedded system.

When the service does not present a manifest file during registration, the one or more computing devices designate the service as a non-critical service and route requests to the service without enhanced protection.

In certain configurations, the request is received through a DBUS interface. The one or more computing devices forward the request through a message bus to the service and receive a response from the service through the message bus.

The one or more computing devices validate, for services requiring the enhanced protection mode, that requests originate from authorized network locations specified in the manifest file.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
obtaining a manifest file for a service executing on an embedded system, the manifest file specifying whether the service requires a simple protection mode or an enhanced protection mode;
registering the service with the confidential computing gateway based on the manifest file;
receiving, at a confidential computing gateway, a request from an interface application to access the service; and
determining, based on the manifest file, whether the service requires the enhanced protection mode.

2. The method of claim 1, further comprising:
when the service requires the enhanced protection mode:
validating the request according to security requirements specified in the manifest file; and
routing the request to the service through a trusted execution environment when the validation succeeds.

3. The method of claim 2, wherein validating the request comprises:
determining whether a payload format of the request matches a signature pattern specified in the manifest file for the service.

4. The method of claim 1, further comprising:
when the service requires the simple protection mode:
routing the request directly to the service without performing additional security validation.

5. The method of claim 1, wherein the manifest file specifies:
a first set of APIs of the service requiring the enhanced protection mode; and
a second set of APIs of the service requiring the simple protection mode.

6. The method of claim 5, further comprising:
routing requests for APIs in the first set through a trusted execution environment; and
routing requests for APIs in the second set directly to the service.

7. The method of claim 1, further comprising:
receiving, from a cloud platform, an updated manifest file for the service; and
updating security requirements for the service based on the updated manifest file during runtime.

8. The method of claim 1, wherein registering the service comprises:
storing, in a configuration database, security requirements specified in the manifest file; and
establishing a communication channel with the service through a message bus.

9. The method of claim 1, wherein the manifest file specifies different access privileges for different user roles, the method further comprising:
determining a user role associated with the request; and
validating the request based on access privileges specified for the determined user role.

10. The method of claim 9, wherein the access privileges specify:
read-only API sets;
read-write API sets; and
file access permissions for each user role.

11. The method of claim 1, further comprising:
receiving requests from multiple interface applications through different protocols;
routing all requests through the confidential computing gateway; and
maintaining a single trust boundary for accessing services requiring the enhanced protection mode.

12. The method of claim 1, wherein the manifest file is generated during a build process of firmware for the embedded system based on deployment requirements of the embedded system.

13. The method of claim 1, further comprising:
when the service does not present a manifest file during registration:
designating the service as a non-critical service; and
routing requests to the service without enhanced protection.

14. The method of claim 1, wherein the request is received through a DBUS interface, the message further comprising:
forwarding the request through a message bus to the service; and
receiving a response from the service through the message bus.

15. The method of claim 1, further comprising:
validating, for services requiring the enhanced protection mode, that requests originate from authorized network locations specified in the manifest file.

16. A system, including one or more computing devices, comprising:
a memory; and
at least one processor coupled to the memory and configured to:
obtain a manifest file for a service executing on an embedded system, the manifest file specifying whether the service requires a simple protection mode or an enhanced protection mode;
register the service with the confidential computing gateway based on the manifest file;
receive, at a confidential computing gateway, a request from an interface application to access the service; and
determine, based on the manifest file, whether the service requires the enhanced protection mode.

17. The system of claim 16, wherein the at least one processor is further configured to:
when the service requires the enhanced protection mode:
validate the request according to security requirements specified in the manifest file; and
route the request to the service through a trusted execution environment when the validation succeeds.

18. The system of claim 17, wherein to validate the request, the at least one processor is configured to:
determine whether a payload format of the request matches a signature pattern specified in the manifest file for the service.

19. The system of claim 16, wherein the at least one processor is further configured to:
when the service requires the simple protection mode:
route the request directly to the service without performing additional security validation.

20. A non-transitory computer-readable medium storing computer executable code for operating one or more computing devices, comprising code to:
obtain a manifest file for a service executing on an embedded system, the manifest file specifying whether the service requires a simple protection mode or an enhanced protection mode;
register the service with the confidential computing gateway based on the manifest file;
receive, at the confidential computing gateway, a request from an interface application to access the service; and
determine, based on the manifest file, whether the service requires the enhanced protection mode.
